(19) United States
(12) Patent Application Publication
(10) Pub. No.: US 2017/0280676 A1
(43) Pub. Date: Oct. 5, 2017

(54) Bowl With Splash Guard

(71) Applicant: Maria Magdalena Mendez, Las Vegas, NV (US)

(72) Inventor: Maria Magdalena Mendez, Las Vegas, NV (US)

(21) Appl. No.: 15/480,003

(22) Filed: Apr. 5, 2017

Related U.S. Application Data
(60) Provisional application No. 62/318,511, filed on Apr. 5, 2016.

(51) Int. Cl. A01K 5/01; A01K 7/00

(52) U.S. Cl. CPC A01K 5/0135; A01K 7/005

(57) ABSTRACT

A bowl with splash guard. The bowl with splash guard includes a bowl comprising a base and a sidewall extending upwardly therefrom defining an interior volume. The splash guard includes a lower wall and a back panel extending therefrom. The splash guard prevents water from spilling when a pet is drinking water from the bowl. The splash guard is removably secured to the bowl so that the bowl and splash guard may be separated for storage or for easy cleaning. The back panel encircles at least half of a circumference of the bowl when secured thereto, which prevents water from spilling from the back and sides of the bowl, while providing a large enough opening for a pet to drink from the bowl.

### CROSS REFERENCE TO RELATED APPLICATIONS

This application claims the benefit of U.S. Provisional Application No. 62/318,511 filed on Apr. 5, 2016. The above identified patent application is herein incorporated by reference in its entirety to provide continuity of disclosure.

### FIELD OF THE INVENTION

The present invention relates to pet food and water bowls. More specifically, the present invention provides a bowl with splash guard for preventing spills when a pet is eating or drinking therefrom.

### BACKGROUND OF THE INVENTION

Many individuals enjoy having pets such as cats or dogs. Pets typically consume food and water from a bowl placed on the floor. When a pet eats or drinks from the bowl, many of them become extremely excited to be doing so. The pet may inadvertently cause food to spill over the edges of the bowl, wasting the food. The food waste can accumulate over time, causing owners to clean up messes and purchase additional food, which can be expensive and time consuming. If the mess is not cleaned up, insects and other pests may infest the home. Similarly, when a pet drinks water from a bowl, it is likely to be spilled around the bowl. This causes another mess that must be cleaned, since the spilled water could cause an individual to accidentally slip and injure themselves. Thus, there is need for an improved food bowl that includes a splash guard for preventing spillage of food and water from a bowl while a pet is eating or drinking from it.

In light of the devices disclosed in the prior art, it is submitted that the present invention substantially diverges in design elements from the prior art and consequently it is clear that there is a need in the art for an improvement to existing animal deterring devices. In this regard the instant invention substantially fulfills these needs.

### SUMMARY OF THE INVENTION

In view of the foregoing disadvantages inherent in the known types of pet bowls now present in the prior art, the present invention provides a bowl with splash guard wherein the same can be utilized for providing convenience for the user when preventing food or water spills. The bowl with splash guard includes a bowl comprising a base and a sidewall extending upwardly therefrom defining an interior volume. The splash guard includes a lower wall and a back panel extending therefrom. The splash guard prevents water from spilling when a pet is drinking water from the bowl. The splash guard is removably secured to the bowl so that the bowl and splash guard may be separated for storage or for easy cleaning. The back panel encircles at least half of a circumference of the bowl when secured thereto, which prevents water from spilling from the back and sides of the bowl, while providing a large enough opening for a pet to drink from the bowl.

One object of the present invention is to provide a bowl with splash guard that prevents spilling of water while a pet drinks from the bowl.

Another object of the present invention is to provide a bowl with a splash guard that is removably so that the bowl and splash guard may be separated for storage or cleaning purposes.

Other objects, features, and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the bowl with splash guard.

FIG. 2 shows an exploded view of the bowl with splash guard.

FIG. 3 shows a top down view of the bowl with splash guard.

### DETAILED DESCRIPTION OF THE INVENTION

Reference is made herein to the attached drawings. Like reference numerals are used throughout the drawings to depict like or similar elements of the bowl with splash guard. For the purposes of presenting a brief and clear description of the present invention, the preferred embodiment will be discussed as used for providing a bowl with a removable spill prevention mechanism. The figures are intended for representative purposes only and should not be considered to be limiting in any respect.

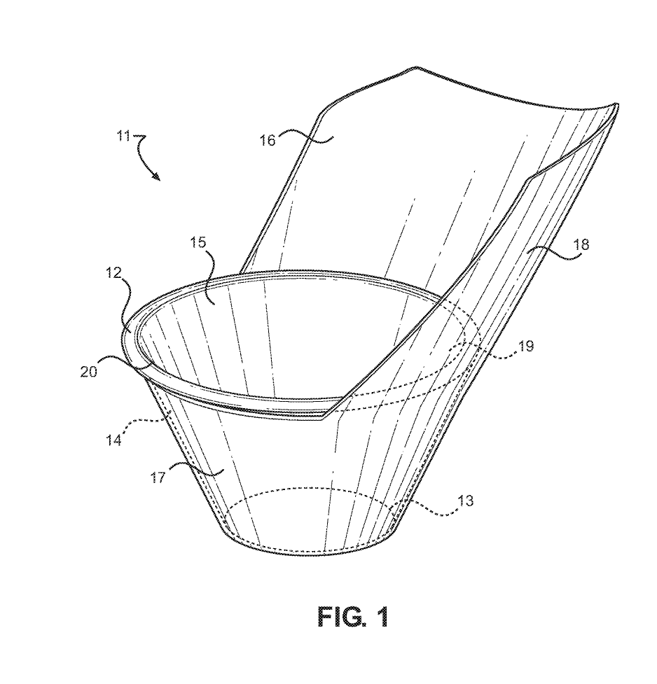

Referring now to FIG. 1, there is shown a perspective view of the bowl with splash guard. The bowl with splash guard 11 generally comprises a bowl 12 having a base 13 and a sidewall 14 extending upwardly therefrom. The base 13 and sidewall 14 define an interior volume 15 bounded by an open upper end 19. In the illustrated embodiment, the sidewall 14 tapers inwardly from the open upper end 19 toward the base 13.

A splash guard 16 is removably securable to the bowl 12. The splash guard 16 includes a lower wall 17 that encircles the sidewall 14 of the bowl 12. A back panel 18 extends upwardly from the lower wall 17. The back panel 18 prevents food and water from spilling out of the bowl 12 onto the floor. The lower wall 17 forms an interior volume that is substantially the same as the interior volume 15 of the bowl 12. The bowl 12 occupies the interior volume of the splash guard 16, such that the lower wall 17 is flush with the sidewall 14 when the splash guard 16 is removably secured to the bow 121. The splash guard 16 can be secured to the bowl 12 via a friction fit. Alternatively, the bowl 12 can rest loosely within the interior volume of the splash guard 16 so that it may be easily separated therefrom when not in use.

The bowl 12 further comprises a lip 20 disposed around the open upper end 19. The lip 20 extends outwardly from the sidewall 14. The bottom of the lip 20 contacts the lower wall 17 of the splash guard 16.

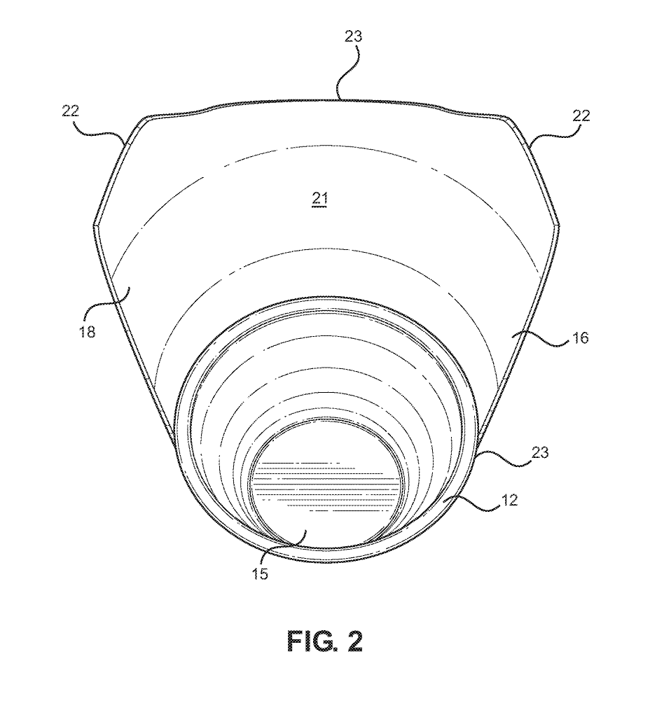

Referring now to FIG. 2, there is shown a top down view of the bowl with splash guard. The width of the splash guard 16 is greater at an upper edge 23 thereof than at the bowl 12. In the illustrated embodiment, the splash guard 16 further includes corner cutouts 22 on opposing sides thereof. Additionally, the splash guard 16 extends around half of the circumference 23 of the bowl 12. In an alternate embodiment, the back panel encircles at least two thirds of a circumference 23 of the bowl 12 when removably secured thereto.

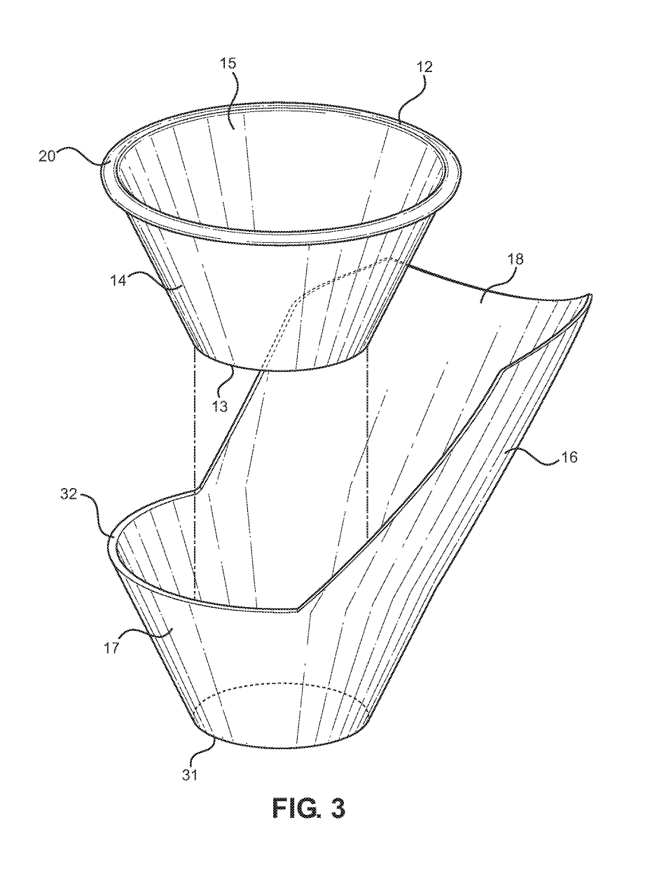

Referring now to FIG. 3 there is shown an exploded view of the bowl with splash guard. In one embodiment, the splash guard 16 has an open lower end 31, such that a base 13 of the bowl 12 still contacts the ground when the splash guard 16 is secured thereto. In the above embodiment, the base 13 may include a high-friction material disposed thereon, in order to prevent the bowl from sliding across the floor unnecessarily.

In an alternate embodiment, the splash guard 16 has a closed lower end 31. In the embodiment where the splash guard 16 has the closed lower end 31, the closed lower end 31 may have a high-friction material disposed thereon, so as to prevent the bowl 12 and splash guard 16 from being slid across the floor while a pet is eating or drinking, further reducing the chance of a spill occurring.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A bowl with splash guard, comprising:
a bowl comprising a base and a sidewall extending upwardly therefrom defining an interior volume bound by an open upper end;
a splash guard comprising a lower wall and a back panel extending therefrom;
wherein the splash guard is removably secured the bowl; and
wherein the back panel encircles at least half of a circumference of the bowl when secured thereto.

2) The bowl with splash guard of claim 1, wherein the sidewall tapers inwardly from the open upper end to the base.

3) The bowl with splash guard of claim 1, wherein an upper edge of the bowl comprises a lip thereon.

4) The bowl with splash guard of claim 1, wherein a width of the back panel increases as it extends upward from the base of the bowl.

5) The bowl with splash guard of claim 1, wherein the splash guard is removably secured to the bowl via a friction fit.

6) The bowl with splash guard of claim 1, further comprising a high friction material disposed on a lower surface of the base.

7) The bowl with splash guard of claim 1, wherein the back panel encircles at least two thirds of a circumference of the bowl when secured thereto.

8) The bowl with splash guard of claim 1, wherein the lower wall is flush with the sidewall when the splash guard is removably secured to the bowl.

9) The bowl with splash guard of claim 1, wherein the back panel comprises a closed lower end.

10) The bowl with splash guard of claim 1, wherein the back panel comprises an open lower end.

11) The bowl with splash guard of claim 1, wherein the bowl is configured to nest within the splash guard.
